(19) United States
(12) Patent Application Publication
(10) Pub. No.: US 2009/0245617 A1
(43) Pub. Date: Oct. 1, 2009

(54) System and method for processing image data

(76) Inventors: Nina Bhatti, Los Altos, CA (US); Terrie A. Sima, Santa Cruz, CA (US); Sabine Susstrunk, Lausanne (CH); Henry Harlyn Baker, Los Altos, CA (US); Michael Harville, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/411,244

(22) Filed: Mar. 25, 2009

Related U.S. Application Data
(63) Continuation of application No. 11/007,430, filed on Dec. 7, 2004.

(51) Int. Cl. G06K 9/00; G06Q 10/00; G06Q 30/00; G06Q 50/00; G06F 17/00

(52) U.S. Cl. 382/141; 705/10; 705/27; 707/104.1; 707/E17.001

(57) ABSTRACT

Embodiments of the present invention recite a system for providing product consulting using a transmitted image. In one embodiment, the present invention comprises an image capture device for capturing an image of a user and a reference color set. In embodiments of the present invention, the image capture device does not require a provided infrastructure when capturing the image. The system further comprises a categorizing system for determining at least one data category from data comprising the image. A result generator generates a result based upon the determining of the categorizing system. The system further comprises a result reporting system for conveying the product consultation to the user when the result is conveyed.

### TECHNICAL FIELD

Embodiments of the present invention are related to product consultation of personal appearance related products.

### BACKGROUND ART

For many customers of cosmetics or other appearance related products, making a purchase decision is difficult due to the wide variety of variables involved in the purchase decision and the wide range of cosmetics products from which the customer can choose. As a result, there are hundreds of cosmetics products in shades which complement or contrast the user's natural complexion color. Additionally, makeup styles change seasonally, and the time of day and location where the user will be may also affect the user's decision regarding which product will be worn. For example, a user may want to present a different appearance during the day at an office than at night at a casual event. Hence, the cosmetics may need to be adjusted based upon the user's intended use.

Thus, many customers desire advice to help them come to a decision regarding cosmetics purchases. However, many retail stores only provide display space for cosmetics, but do not provide trained personnel who help the customer come to a decision regarding cosmetics purchases. Additionally, the ambient lighting at many retail stores can distort the customer's skin coloration, thus giving the customer a false impression of how the cosmetics look on their skin. For example, many retail stores use fluorescent lighting which radiates light with a slightly bluish tint. Also, some stores use coatings on their windows which filter natural sunlight in a particular range of the visible spectrum. Thus, many customers are making a “best guess” as to whether the cosmetics product is acceptable when worn by that particular user. As a result, customers often purchase cosmetics based upon how they look in the store only to find that they do not like how the cosmetics look when they get home. Additionally, for some types of cosmetics products (e.g., lipstick), the customer is not allowed to sample the product before purchase due to health concerns.

Another disadvantage with some retail stores is that the manufacturer is not able to develop a relationship with the customer. The personnel at these stores typically have little interest in whether the customer purchases cosmetics or if the customer is satisfied with their purchase decision. Thus, these employees have little interest in representing a particular cosmetics brand in a manner which will persuade the customer to purchase that brand again. However, many manufacturers would like to provide some consultation service for customers that would result in greater customer satisfaction, which in turn would result in more sales.

Alternatively, many high-end cosmetics manufacturers operate their own proprietary retail space, also known as “makeup counters,” within retail stores. These makeup counters are staffed with trained representatives who can provide advice to the customer as to which cosmetic shades are complementary to the skin coloration of that particular customer as well as current styles among which the customer may choose. Thus, the customer is presented with a smaller range of products from which to choose, but which are more suited for that customer based upon her needs. Additionally, the representatives can recommend other products which may complement the purchase being made by the customer and provide advice regarding current fashion trends.

At very high end retail spaces, the manufacturer may provide a controlled environment in which the lighting is carefully calibrated to provide the customer an accurate impression of what the cosmetics will look like when the customer leaves the store. Unfortunately, the cosmetics products sold by these manufacturers are typically much more expensive than those sold at the retail stores which do not provide any consultation. Additionally, some customers are intimidated by the trained representatives and/or do not want to discuss something as personal as their appearance with a stranger. Again, the end result is that some customers who may benefit from receiving a cosmetics consultation do not receive the advice they seek.

### DISCLOSURE OF THE INVENTION

Embodiments of the present invention recite a system for providing product consulting using a transmitted image. In one embodiment, the present invention comprises an image capture device for capturing an image of a user and a reference color set. In embodiments of the present invention, the image capture device does not require a provided infrastructure when capturing the image. The system further comprises a categorizing system for determining at least one data category from data comprising the image. A result generator generates a result based upon the determining of the categorizing system. The system further comprises a result reporting system for conveying the product consultation to the user when the result is conveyed.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 shows a system for providing product consulting using an image capture device in accordance with embodiments of the present invention.

FIG. 2 shows an image capture system used in a system for providing product consulting in accordance with embodiments of the present invention.

FIG. 3 is a block diagram of an image capture device used in embodiments of the present invention.

FIG. 4 is a block diagram of a categorizing system for providing product consulting in accordance with embodiments of the present invention.

FIG. 5 is a flowchart of a method for providing product consulting in accordance with embodiments of the present invention.

FIG. 6 is a block diagram of an exemplary computer system upon which embodiments of the present invention may be implemented.

### MODES FOR CARRYING OUT THE INVENTION

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “capturing,” “determining,” “requiring,” “generating,” “performing,” “accessing,” “conveying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

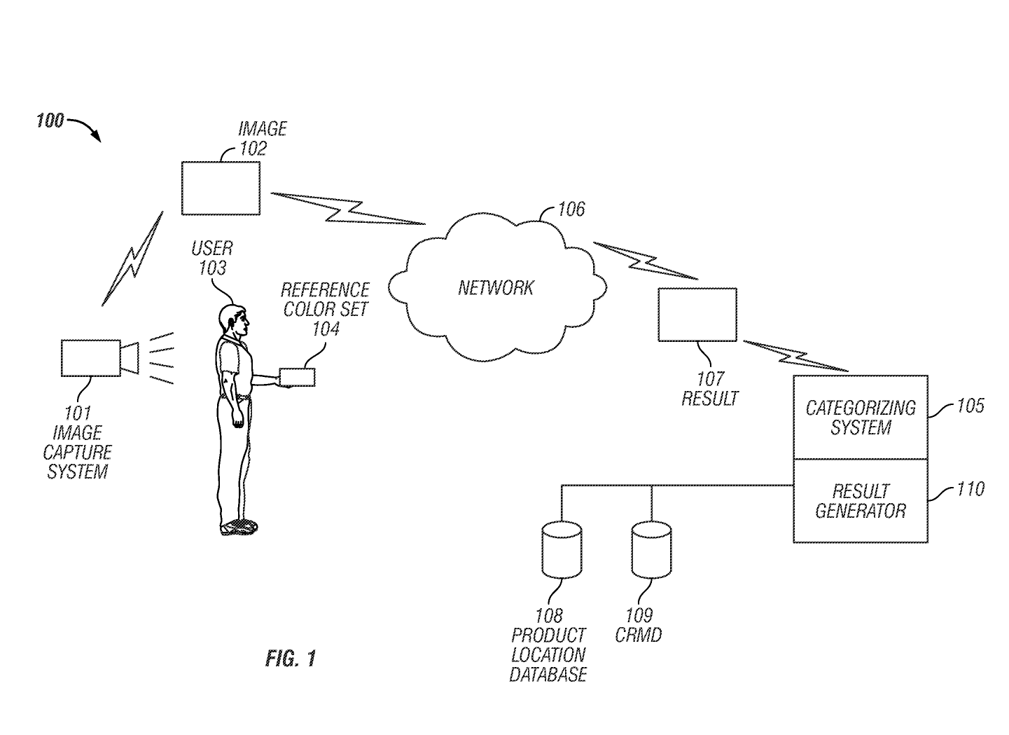

FIG. 1 shows system 100 for providing product consulting using an image capture device in accordance with embodiments of the present invention. In embodiments of the present invention, system 100 comprises an image capture system 101 for capturing an image 102 of a user (e.g., 103) and a reference color set 104. It should be noted that embodiments of the present invention are dependent upon using a reference color set with a known set of spectral reflectance and/or color signal values. In embodiments of the present invention, image capture system 101 does not require a provided infrastructure when capturing image 102. For example, image capture system 101 may be a user's personal computer system, digital camera, or a cellular telephone capable of generating photographs (e.g., referred to herein as a “picture phone”). Thus, rather than relying upon calibrated equipment (e.g., calibrated cameras and/or calibrated lighting), embodiments of the present invention may utilize end user equipment during the product consultation process.

Returning to FIG. 1, image 102 is then conveyed to a categorizing system 105 via network 106. In embodiments of the present invention, categorizing system 105 may be implemented as a web site, thus providing a web-page interface for user 103. This is advantageous for providing additional information which might not be conveyed using image 102 alone. Categorizing system 105 is for determining at least one data category that best represents the data comprising image 102. In the present embodiment, the at least one data category comprise ranges of skin coloration to which user 103 is matched based upon an analysis of image 102. For the purposes of the present invention, it should be understood that a data category refers to a range of various skin colorations which may be considered an equivalence class. Furthermore, determining which data category best represents the data comprising image 102 may be based upon a probabilistic model. Thus, it is possible that the data comprising image 102 may be associated with more than one data category in embodiments of the present invention. Categorizing system 105 is coupled with a result generator 110 for generating a product consultation result 107 based upon determining which one or more particular data categories most closely match the skin coloration of user 103. Furthermore, result generator 110 may be communicatively coupled with a product location data base (e.g., 108) and/or a customer relationship management database (CRMD) 109.

System 100 further comprises a result reporting system (e.g., network 106) for conveying result 107 to user 103. As will be discussed in greater detail below, embodiments of the present invention utilize a variety of result reporting systems in accordance with the type of result being generated by categorizing system 105. In embodiments of the present invention, result 107 conveys a product consultation to the user 103 typically comprising at least one personal appearance related product such as makeup or another cosmetics product. For clarity, the following discussions will be directed toward product consultations of makeup or other cosmetics products. However, while the present invention is discussed in the context of conveying information about cosmetics products, embodiments of the present invention are well suited for conveying other types of information to user 103.

Embodiments of the present invention are advantageous in that they do not need a provided infrastructure (e.g., calibrated cameras and/or calibrated lighting or ambient conditions) when capturing image 102. Previously, some cosmetics manufacturers provided a dedicated room or kiosk in which the ambient lighting conditions and/or the camera processing parameters were carefully calibrated. This was necessary to facilitate making an accurate assessment of the skin coloration of the user. A picture of the user was taken and analyzed by a human consultant who then provided a cosmetics consultation to the user. However, due to the expense and amount of space these facilities required, they were not generally made available to most users.

Embodiments of the present invention do not require a provided infrastructure because categorizing system 105 utilizes the received image of reference color set 104 to compensate for the ambient lighting conditions and image processing parameters of image capture system 101. For example, categorizing system 105 may compare the color signal values of the received image of reference color set 104 with a known set of color signal values of reference color set 104. As a result, embodiments of the present invention do not rely upon calibrated cameras or calibrated lighting when capturing an image of user 103. By performing this analysis, categorizing system 105 can infer the combined effects of the ambient lighting conditions of the location at which user 103 is located and the image processing capabilities of image capture system 101. Categorizing system 105 can then determine what adjustments are necessary so that the received image of reference color set 104 corresponds with the known spectral reflectance and/or color signal values of the reference color set. Categorizing system 105 can thus infer the true skin coloration of user 103 and, based on this analysis, generate a cosmetics consultation. While the present invention recites that a provided infrastructure is not required, embodiments of the present invention may be used with a provided infrastructure as well.

Because there is no requirement for a provided infrastructure, embodiments of the present invention facilitate providing cosmetics consultation in retail outlets which may not have the resources for providing a dedicated makeup consultation counter. Thus, if user 103 purchases cosmetics from a retailer that does not have personnel trained to perform cosmetics consultations, and/or the space for the provided infrastructure described above, user 103 can still receive a cosmetics consultation using embodiments of the present invention. Because users may be more likely to buy cosmetics products from a manufacturer that provides cosmetics consultation, embodiments of the present invention are advantageous for cosmetics manufacturers who can suggest a whole range of related products and develop a relationship with user 103 that is not possible when user 103 is simply selecting from a shelf stocked with cosmetics products. Furthermore, users who might be uncomfortable receiving a cosmetics consultation from a total stranger could receive an anonymous cosmetics consultation using embodiments of the present invention. The cosmetics consultation may even be received by the users in their homes or other locations away from the retail outlets.

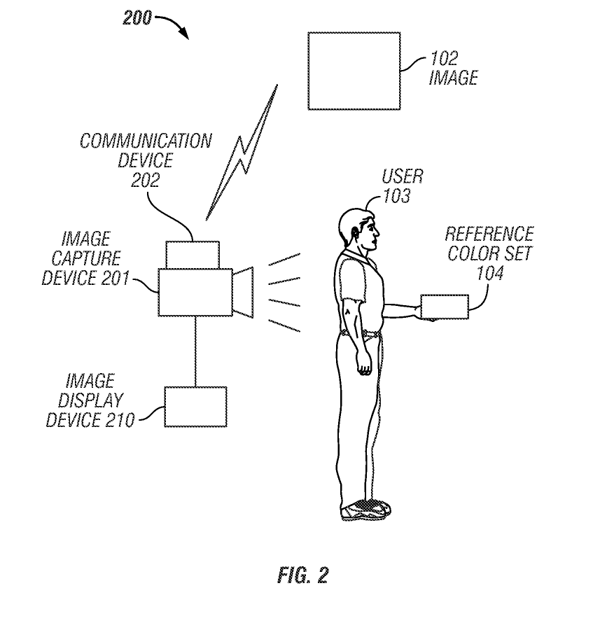

FIG. 2 shows an image capture system 200 used in a system for providing product consulting in accordance with embodiments of the present invention. In embodiments of the present invention, image capture system 200 comprises an image capture device 201, a reference color set (e.g., reference color set 104 of FIG. 1), and a communication device 202 coupled with image capture device 201. In embodiments of the present invention, image capture device 201 may comprise personal property of end user 103 such as a picture phone, a digital camera, a personal digital assistant (PDA), a personal computer system, a digital video recorder, or a similar device capable of capturing an image. However, embodiments of the present invention may also be used in. proprietary systems in which a manufacturer provides a kiosk or other automated system for providing product consultation.

Because there is no need for a provided infrastructure, user 103 may use their own equipment (e.g., image capture device 201) in a wide variety of locations other than a retail store in order to receive a product consultation. For example, user 103 can utilize embodiments of the present invention in their own home, while walking outdoors, or another location as long as they can communicate with categorizing system 105. However, other embodiments of the present invention, may be implemented using a provided infrastructure which can be located, for example, in a retail outlet or as a product consultation kiosk at a mall. A provided infrastructure may also comprise an image display device 210 which can be used for displaying an image of a recommended product and/or an image of user 103 which conveys, for example, the appearance of user 103 wearing a recommended product.

As described above, reference color set 104 is conveyed with the image (e.g., 102) that is generated by image capture device 201. Reference color set 104 provides a baseline which is used by categorizing system 105 to determine at least one data category from data comprising image 102. For example, in embodiments of the present invention, categorizing system 105 compares the reference color set received in image 102 with the known surface reflectance values of the reference color set.

Color checking charts are widely used in photography and related fields to determine the color balance of a given color imaging or rendering system. They were developed to ensure that the colors rendered by, for example, cameras, televisions, scanners, monitors, etc., were an accurate representation of the colors of the object being reproduced. Color checking charts provide a baseline standard against which the rendered colors in an image can be compared to determine the type and magnitude of errors in reproducing the image. This comparison may be made automatically using optical density measurements. In embodiments of the present invention, reference color set 104 may represent a range of complexion colors, a range of other colors used in standardized color checker charts, or a combination of both.

There are a variety of methods for incorporating reference color set 104 into image 102. For example, a reference color set 104 may be printed on a card which is sent in a mailing to user 103 or inserted into a magazine. Alternatively, an advertisement in a magazine may be printed in the colors which comprise reference color set 104. User 103 can simply hold the magazine advertisement or the color strip such that it is visible when image 102 is generated. In another embodiment, an in-store display can be printed in the colors which comprise reference color set 104 and user 103 can stand in front of the in-store display when image 102 is generated. The colors comprising reference color set 104 will then be visible as a background of image 102. In embodiments of the present invention, the colors comprising reference color set 104 may be incorporated into a picture or other image and thus not be apparent to user 103 that reference color set 104 is present in image 102.

In embodiments of the present invention, communication device 202 may implement a variety of wired or wireless communication technologies. For example, communication device 202 may utilize a dial-up Internet connection, a public switched telephone network (PSTN), a high-speed network connection (e.g., cable Internet, or high-speed computer network), or the like. Alternatively, communication device 202 may utilize a cellular telephone connection, a satellite telephone connection, a radio connection, an infra-red communication connection, or the like. Communication device 202 is for conveying the image (e.g., 102 of FIG. 1) generated by image capture device 201 to a categorizing system (e.g., 105 of FIG. 1). However, as will be discussed in greater detail below, embodiments of the present invention do not require that image 102 be conveyed to a separate system from image capture system 200.

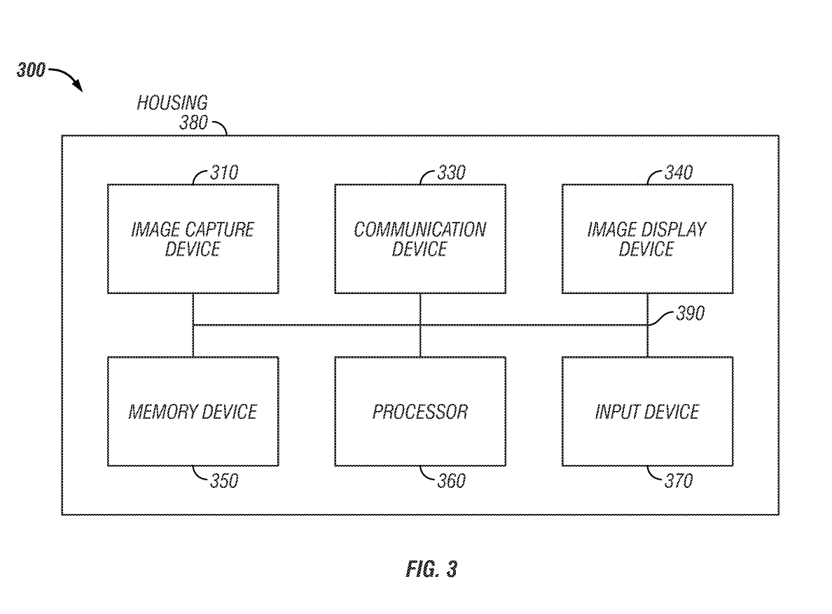

FIG. 3 is a block diagram of an exemplary image capture device 300 used in embodiments of the present invention. In embodiments of the present invention, image capture device 300 comprises a mobile electronic device. It is appreciated that the image capture system discussed in the following discussion may be comparable to image capture device 101 of FIG. 1 and image capture device 201 of FIG. 2. In FIG. 3, an image capture device 310 coupled with a communication device 330, an image display device 340, a memory device 350, a processor 360 and an input device 370 via a bus 390. In the embodiment of FIG. 3, these components are disposed within a housing 380. While the present embodiment recites these components specifically, embodiments of the present invention do not require that image capture device 300 comprises all of these components.

As discussed above with reference to FIG. 2, image capture device 300 may comprise personal property of an end user (e.g., 103) such as a picture phone, a digital camera, a personal digital assistant (PDA), a personal computer system, a digital video recorder, or a similar device capable of capturing an image. Alternatively, image capture device may comprise a kiosk or other automated system for providing product consultation which is provided by, for example, a retail outlet or a manufacturer that is providing product consultation.

In embodiments of the present invention, image capture device 310 comprises a digital camera or similar device. As discussed above, image capture device 310 is for capturing and generating an image of a user and a reference color set (e.g., 104).

As discussed above with reference to FIG. 2, communication device 330 is for conveying image 102 to categorizing system 105 and for receiving a response from categorizing system 105. However, as discussed above with reference to FIG. 2, embodiments of the present invention do not require that image 102 be conveyed outside of device 300. For example, in embodiments of the present invention, categorizing system 105 comprises a computer program for analyzing an image (e.g., 102) and categorizing the user (e.g., 103) based upon the skin coloration of the user. In embodiments of the present invention, this computer program may comprise computer software and/or computer firmware instructions resident in memory device 350 as well as computer software and/or computer firmware instructions to perform the function of result generator 110. As a result, embodiments of the present invention facilitate using system 300 as a portable cosmetics consultation system.

In embodiments of the present invention, communication device 330 is for sending and/or receiving a message comprising, but not limited to, a voice message, a short message service (SMS) message, a multi-media message service (MMS) message, a voice extensible mark-up language (voice XML) message, an e-mail message, an instant message, or another form of electronic communication.

System 300 further comprises an optional image display device 340 for displaying images and/or projecting an image. As will be discussed in greater detail below, in embodiments of the present invention, categorizing system 105 may send a message comprising an image or image data to image capture device 300.

System 300 further comprises a memory device 350 for storing digital data and instructions. In embodiments of the present invention, memory device 350 may be a non-volatile memory device (e.g., a flash memory device, a programmable read only memory device (PROM), an electrically erasable PROM (EEPROM), etc.) a volatile memory device, a removable memory device (e.g., a memory stick, a compact flash removable device, a MultiMediaCard memory device, a Secure Digital Input/Output (SDIO) card, or a removable memory device such as a writeable optical disk). As described above, in embodiments of the present invention, memory device 350 can store computer program instructions for performing a method for providing product consultation. Thus, embodiments of the present invention may comprise a complete portable system for providing a product consultation.

Processor 360 is for processing digital information and instructions for performing a method for providing product consultation in accordance with embodiments of the present invention.

System 300 further comprises an input device 370. Input device 370 may comprise, for example, an alpha-numeric keyboard, touch pad, joystick, cursor controller, or the like for inputting data and controlling functions of system 300. Input device 370 facilitates user input to, for example, enter personal information such as age, name, address, and to identify parameters which can be used by categorizing system 105 to generate a product consultation.

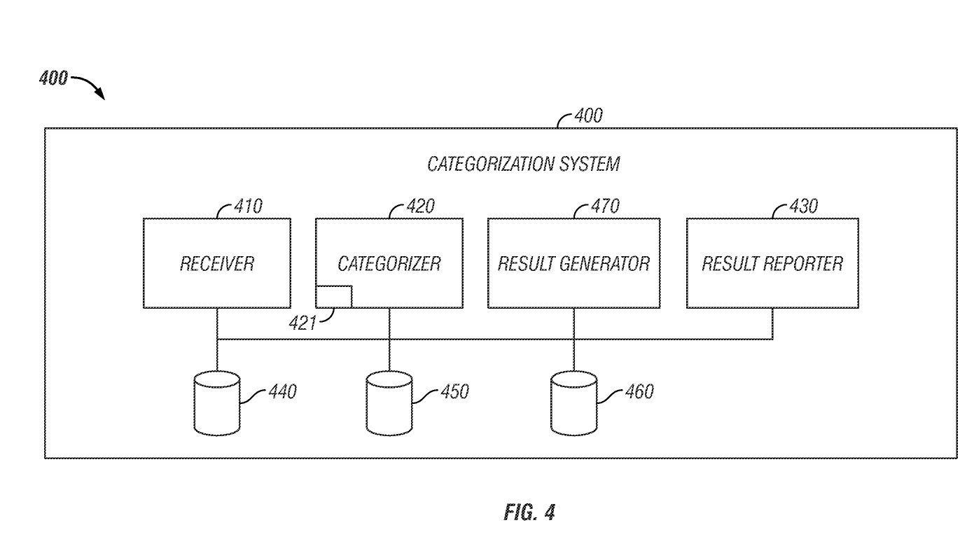

FIG. 4 is a block diagram of categorizing system 400 for providing product consulting in accordance with embodiments of the present invention. In embodiments of the present invention, categorizing system 400 comprises a receiver 410 that is communicatively coupled with a categorizer 420, a result reporter 430, a product database 440, a product location database 450, a customer relationship management database 460, and a result generator 470. In embodiments of the present invention, categorizing system 400 may be implemented as a single device (e.g., as a product consultation server, or a mobile product consultation device), or as a network of devices. Additionally, various components shown in FIG. 4 may be integrated into a single component (e.g., product database 440, product location database 450, and customer relationship management database 460 may be integrated into a single database), or may be implemented in a distributed fashion.

Receiver 410 is for receiving image 102 from an image capture device and for conveying it to categorizer 420. Receiver 410 is also for receiving additional information which a user may optionally provide to better identify a range of products in which the user is interested. In embodiments of the present invention, receiver 410 may also convey a response from categorizing system 400 back to user 103.

In embodiments of the present invention, categorizer 420 is for determining at least one data category from data comprising image 102. In embodiments of the present invention, categorizer 420 performs a process known as “binning.” Typically, binning is a process in which the spectrum of complexion colors is divided into a set of discreet groups or “bins”. Thus, each bin defines a subset of the spectrum of complexion colors. In embodiments of the present invention, once the skin coloration of user 103 is determined by categorizer 420, user 103 can be associated with a particular bin which matches that user's skin coloration. For example, a user with a light complexion might be associated with bin seven, while another user with a darker complexion might be associated with bin nineteen.

Additionally, in embodiments of the present invention, the bin sizes may not be uniform. In other words, some bins may define a larger portion of the spectrum of complexion colors than other bins. For example, users with lighter complexions typically require a greater degree of granularity than users with darker complexions because they are trying to conceal blemishes and/or sun damage to their skin which are more apparent on light complexions. Conversely, users with darker complexions tend to want to even their skin tone rather than conceal blemishes. As a result, fewer bins have been found to be sufficient for users with darker complexions.

The following discussion is an exemplary description of a method of categorizing a user's image in accordance with embodiments of the present invention. In order to analyze the image of a user to identify the user's skin coloration, a selection of image skin color regions representative of the user's true skin color is made. Selecting these elements of the user's face and head to sample for color values involves identifying the location and orientation of the user's face within the image. Furthermore, a determination of where within the face to collect appropriate skin coloration measurements is made. Embodiments of the present invention may be configured to determine which regions of a user's face (e.g., the forehead, cheeks, chin, etc.) are highly predictive of overall face coloration. This ensures that coloration of the skin itself, and not freckles, blemishes, hair color, eye color, or other incorrect values, is measured. In embodiments of the present invention, techniques known to practitioners of computer vision facilitate making these determinations. For example, heads can be detected through various computer implemented “face-detection” methods and the orientation of the head can be determined through techniques such as mesh-fitting to derived control points. Samples of skin coloration can then be selected from known locations on these meshes. Alternatively, statistical analysis of skin color without mesh fitting can also be used to estimate skin coloration. Validation of the samples as being representative of the appropriate skin coloration can be performed using standard outlier rejection principles. The result is a set of skin measurements that is substantially free of defect or extraneous material and which provides a usable sampling of the user's skin coloration. Furthermore, while the present embodiment teaches determining which regions of a user's face are representative of the user's true skin color, in other embodiments of the present invention are well suited to analyzing the skin coloration of the user's entire face. This may also comprise excluding some areas such as the eyes, hair, facial hair, etc. which are not representative of the user's skin coloration.

The quality and spectral characteristics of light falling on a given user affect the user's appearance to a camera and thus on the image generated by the camera. The camera itself, through physical characteristics of its design and fabrication, and also through internal processing characteristics of the camera, introduces further alteration in the perceived skin coloration of the user. These effects combine to make skin coloration metrics of image 102 highly dubious. By viewing a set of reference colors (e.g., 104) captured along with the image of the user, embodiments of the present invention may facilitate determining a transformation from the observed color space of image 102 to a reference or “true” color space.

In the embodiment of FIG. 4, this true color space is represented by a second reference color set 421. It is appreciated that second reference color set 421 may comprise a logical reference color set in which the spectral reflectance and/or color signal values of reference color set 104 are accessed, rather than an actual physical entity. Since categorizer 420 can access the characteristics of second reference color set 421, categorizer 420 can determine a transformation which accounts for the discrepancy between the first, imaged reference color set captured in image 102 and the second, accessed reference color set characteristics. This transformation directly compensates for the combined effect of the ambient lighting in the room and the color transformation of the acquiring camera (e.g., 101). To facilitate determining this reference transformation, categorizer 420 detects imaged color set 104 within image 102, measures the observed characteristics of the imaged color set 104, and determines a transformation that brings colors of the imaged reference color set 104 optimally close to the colors of second reference color set 421. This transformation is also applied to the image of user 103 within image 102 to thus obtain the “true” skin coloration of user 103 in the color space in which the second reference color set 421 is specified. In another embodiment, imaged reference color set 104 may comprise a plurality of skin coloration tones and categorizer 420 simply compares the skin coloration of user 102 with the imaged reference color set 104 to determine a bin to which user 103 is assigned.

In embodiments of the present invention, a further transformation in the skin coloration may map observed skin coloration to subcutaneous pigmentation values, thus providing a connection with established pigment and/or color recommendation routines. These subcutaneous values may be unobservable to ambient-illuminated image capture devices.

In embodiments of the present invention, color transformation may be applied to all image pixels prior to further processing and analysis steps. In some embodiments, color transformation is only applied to a selected subset of the pixels determined to be representative of the overall skin coloration of the user. This likelihood may be determined as described above, or utilize other image analysis techniques. In some embodiments of the present invention, color transformation is applied to aggregate skin coloration statistics, such as the mean or median, obtained from pixels determined as likely to pertain to the user.

Having performed the analysis described above, categorizer 420 has determined the likely skin coloration of user 103. This coloration is compared with the bins described above to determine which bin or bins most closely matches the skin coloration of user 103. In embodiments of the present invention, one or more classifiers is used to map facial color measurements to, for example, labeled categories (e.g., bins). In embodiments of the present invention, the bins may also further segment the population according to other factors such as hair color, age, and geographic location. The set of bins used by embodiments of the present invention may not include all people of a given population. Example data for the skin coloration and, optionally, other characteristics of people in each bin are used to construct one or more classifiers that, when presented with the measurements for user 103, usually assign user 103 to a bin or bins whose members closely match that of user 103.

Embodiments of the present invention use different types of measurement data to construct the bins. For example, the bins may be constructed using, for each user, a description of a single point in some color space (e.g., hue-saturation-value (HSV)) that is taken to represent the overall skin coloration of user 103. In other embodiments, this single point may be supplemented with additional points describing hair, lip, and/or eye color. In other embodiments, the single point may be replaced with multiple points corresponding to skin coloration at important facial or body locations (e.g., cheek, forehead, and/or neck). In some embodiments, the measurement may consist of a color range describing the user's skin coloration. In other embodiments, measurement data may include age, geographic location, and other non-appearance related data of user 103.

Embodiments of the present invention may use any of a number of different types of classifier to map user measurements to classes. For example, nearest neighbor classifiers, Gaussian mixture models (GMMs), neural networks, support vector machines (SVMs), classification and regression trees (CART), and hidden Markov models (HMMs) may be used separately or in combination in various embodiments of the present invention.

Once the classifiers assign a person to a bin or bins based upon that user's skin coloration measurements and, optionally, other data, skin product recommendations can be made that are well suited to people in that bin(s). The different bins are typically associated with different skin product recommendations that are stored in, for example, product database 440. This may be accomplished by using different recommendation algorithms for each class, different recommendation templates, or other means which allow categorizing system 400 to perform cosmetic product recommendations typically performed by a makeup representative.

Thus, categorizer 420 determines the user's skin coloration based upon an analysis of the image (e.g., 102) of the user (e.g., 103) and a comparison of the reference color set (e.g., 104) in the image with the known characteristics of the reference color set (e.g., 421). Then, each user is mapped to a particular bin or plurality of bins based upon that user's skin coloration. Because there is a mapping between each bin and a range of personal appearance related products which are considered suitable for a person having that skin coloration, embodiments of the present invention can generate a recommendation for that user of, for example, makeup products or other appearance related products which are considered suitable for that user.

In embodiments of the present invention, user 103 can identify additional parameters which are used by categorizer 420 to further refine which makeup products are suitable for that user. For example, a teenage demographic group may prefer different styles of makeup, hair care products, etc., than are preferred by older demographic groups. Additionally, the user can specify situations which might define suitable products for that user. For example, a user seeking makeup products which can be worn in an office or professional setting might not be interested in makeup products which are considered more suitable for evening or formal occasions. Additionally, the use can specify the type of product type in which the user is interested. For example, the user may only be interested in lipstick or foundation and not seek a consultation with regard to other products. Alternatively, the user may specify a whole range of products (e.g., a range of eye makeup products), or colors in which they are interested.

Result generator 470 is for generating a result based upon the determining performed by categorizer 420. For example, based upon the bin with which a particular user is associated, result generator 470 accesses product database 430 to determine which personal appearance related products are suitable for that user. In embodiments of the present invention, result 107 may comprise listing the name of the product(s) which are suitable for the user. The result may also comprise a description and/or commercial commentary about the product(s).

In another embodiment, categorizing system 400 may receive an indication of the present location of user 103. For example, global positioning system (GPS) cards are becoming increasingly common in cellular telephones. Alternatively, the enhanced 911 standards implemented by the Federal Communications Commission (FCC) facilitate determining the location of a cell phone user by triangulating the signal from the cell phone between local cell phone towers. In another embodiment, the area code of the location from which user 103 sends image 102 may be used to identify the location of user 103. Alternatively, the user can use the web page interface to enter their address, or this information may be retrieved if user 103 has previously established a user profile. Using this information result generator 470 may access product location database 450 to determine one or more retail outlets which are proximate to the present location of user 103. Result reporter 430 may then generate a text message to user 103 comprising directions to one of the retail outlets. Alternatively, result generator 470 may generate a map which is sent to user 103 which shows the present location of user 103 and one or more of the retail outlets which are proximate to that location.

In another embodiment of the present invention, result generator 470 may generate a second image which is conveyed to user 103 as result 107. This image may, for example, be displayed by image display device 340 of image capture device 300. In one embodiment, the second image may show one or more of the products which have been determined to be suited to the needs of user 103. For example, result 107 may convey one or more images of a shade of lipstick, or a range of lipstick shades, to user 103. This may be accompanied by a description of each of the products shown in the associated image.

In another embodiment, the image conveyed in result 107 comprises a composite image of user 103 which is altered to represent user 103 wearing the product recommended by categorizer 420. For example, categorizer 420, using the above described face recognition and localization algorithms described above, may determine the areas of the user's face to which a recommended product may be applied. For example, if user 103 is seeking consultation regarding lipstick colors, categorizer 420 may determine which pixels in image 102 comprise the lips of user 103 and, using image editing algorithms, apply the recommended shade of lipstick to those pixels. This image is then sent back to user 103.

In another embodiment, a real-time display system may be used to show this image to user 103. For example, a video camera captures a real time video of user 103 for display on a display device. Result 107 provides information which facilitates altering in real-time the video shown on the display device so that it appears that user 103 is wearing the recommended product. For example, result 107 may indicate which shade of lipstick to display when displaying user 103.

In another embodiment, an interactive product display at the retail outlet where user 103 is located may be used to indicate which product has been recommended as being suitable for the user. When result 107 is conveyed to the interactive product display, it initiates an action by the interactive product display to attract the attention of user 103. For example, a light may come on proximate to the recommended product which indicates to user 103 which particular product has been recommended. In another embodiment, the interactive product display actually dispenses the recommended product in a manner similar to a vending machine in response to result 107 being received.

In another embodiment, result 107 may be used to provide information for prescriptive mixing of an appearance related product. For example, an operator of system 100 may receive information from categorizing system 400 which facilitates custom mixing of makeup for user 103. Thus, the information conveyed in result 107 may convey which pigments to add to a neutrally colored base so that the end product matches the skin coloration of user 103.

In another embodiment, should user 103 indicate approval and provide shipping and payment information (e.g., credit card information), result generator 470 generates result 107 which comprises initiating the shipment of the recommended product to user 103.

In embodiments of the present invention, result reporter 430 may convey result 107, as well as image 102, utilizing a variety of message formats. For example, images may be conveyed using the multimedia messaging service (MMS) or as an embedded image (e.g., in JPEG or GIF format). In other embodiments, a voice message may convey result 107 to the user. This may comprise a voice extensible mark-up language (voice XML) message which is sent by result reporter 430. In another embodiment, a short message service (SMS) message may convey result 107 to the cell phone of user 103. In another embodiment, result 107 is conveyed via the Internet. For example, if user 103 is using a web page interface to categorizer 400, a web page may be displayed which shows the recommended product, or an e-mail may be generated to user 103.

Returning to FIG. 4, customer relationship management database (CRMD) 460 facilitates developing and/or maintaining a relationship with user 103 and storing a skin coloration profile of user 103 based upon the analysis described above. For example, CRMD 460 may generate a customer survey sheet which may be used to provide parameters which define the products that are considered suitable for recommendation to the user. In embodiments of the present invention, the user can provide personal information such as demographic data and/or address information. User 103 may also indicate whether further communication with the manufacturer is desired after a product consultation is provided. This could be used by the manufacturer to, for example, notify user 103 of special events, upcoming sales, new products, or related products which may also be suitable for that user.

In embodiments of the present invention, the information stored in CRMD 460 may be used for targeted advertising. For example, if a new product is developed, CRMD 460 may be used to determine which users, based upon their skin coloration profiles and previous purchases, may be interested in the new product. The information stored in CRMD 460 may also be used if a recommended product is reformulated or a new product is being developed, to identify users which could participate in beta testing. For example, if a new color of lipstick is being developed which is intended for users having a particular skin coloration, users having that skin coloration can be identified using the skin coloration profiles stored in CRMD 460.

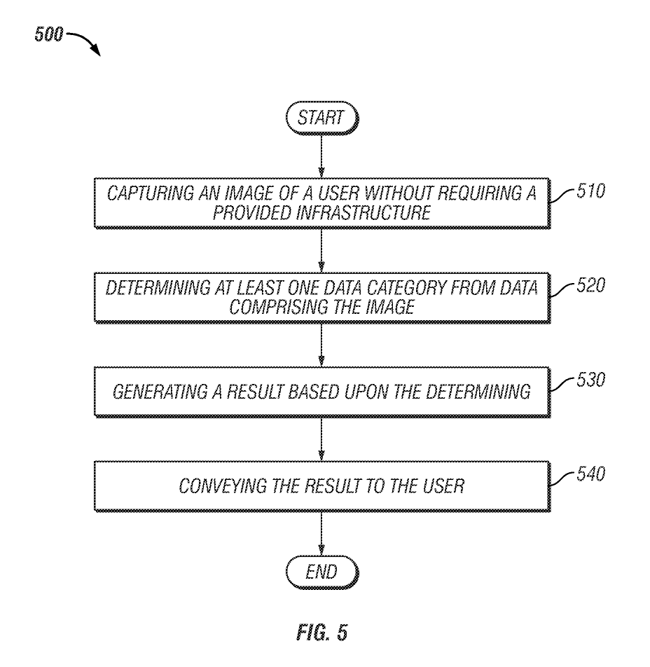

FIG. 5 is a flowchart of a method for providing product consulting in accordance with embodiments of the present invention. In step 510 of FIG. 5, an image of a user is captured without requiring a provided infrastructure. Referring to FIG. 1, image 102 comprises an image of user 103 and reference color set 104. In embodiments of the present invention, user owned/operated equipment (e.g., a digital camera, a picture phone, etc.) can be used to generate image 102. Due to the inclusion of reference color set 104, a provided infrastructure (e.g., a calibrated light source, a calibrated image capture device, etc.) is not required. As a result, embodiments of the present invention provide a substantial cost savings to a manufacturer and/or retail outlet compared to currently implemented systems for providing cosmetics consultations.

In step 520 of FIG. 5, at least one data category is determined from data comprising the image. As described above with reference to FIG. 4, categorizer 420 analyzes image 102 and determines which bin or plurality of bins most closely matches the skin coloration of user 103.

In step 530 of FIG. 5, a result is generated as a result of the determination of step 520. In response to the analysis performed in step 520, one or more personal appearance related products which are associated with the selected bin(s) are associated with user 103. A result, conveying information about the personal appearance related product(s) is generated by result reporter 430.

In step 540 of FIG. 5, the result generated in step 530 is conveyed to the user. As described above with reference to FIG. 4, result 107 is sent to user 103 which conveys a product consultation. In embodiments of the present invention, this may comprise a description of the recommended product, an indication of where the recommended product is located, an image, and/or the initiation of shipment of the recommended product.

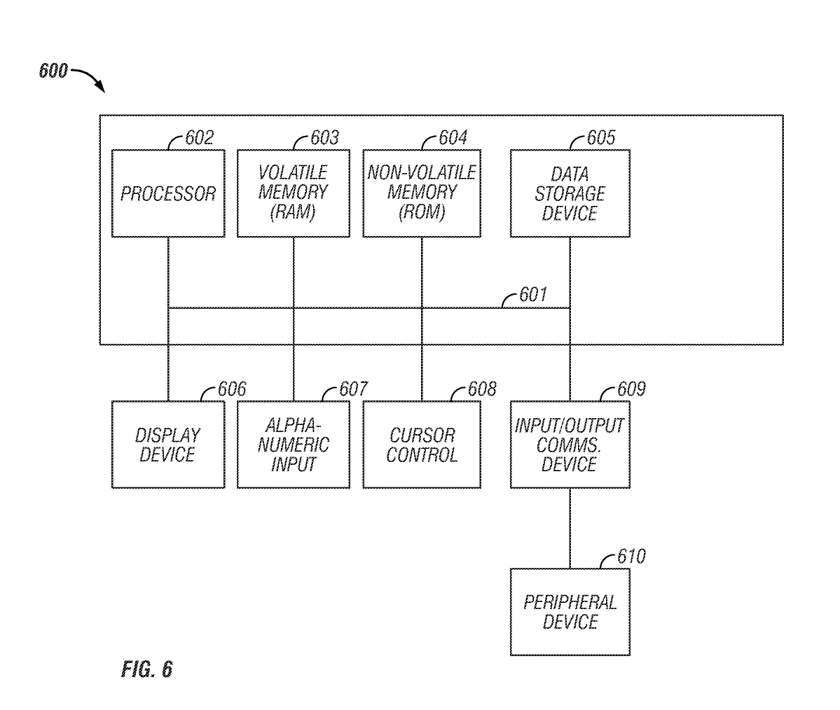

FIG. 6 is a block diagram of an exemplary computer system 600 upon which embodiments of the present invention may be implemented. In embodiments of the present invention, portions of the present invention are comprised of computer-readable and computer-executable instructions that reside, for example, in computer system 600 which is used as a part of a general purpose computer network (not shown). It is appreciated that computer system 600 of FIG. 6 is exemplary only and that the present invention can operate within a number of different computer systems including general-purpose computer systems, embedded computer systems, laptop computer systems, hand-held computer systems, and stand-alone computer systems.

In the present embodiment, computer system 600 includes an address/data bus 601 for conveying digital information between the various components, a central processor unit (CPU) 602 for processing the digital information and instructions, a volatile main memory 603 comprised of volatile random access memory (RAM) for storing the digital information and instructions, and a non-volatile read only memory (ROM) 604 for storing information and instructions of a more permanent nature. In addition, computer system 600 may also include a data storage device 605 (e.g., a magnetic, optical, floppy, or tape drive or the like) for storing vast amounts of data. It should be noted that the software program for performing product consulting of the present invention can be stored either in volatile memory 603, data storage device 605, or in an external storage device (not shown).

Devices which are optionally coupled to computer system 600 include a display device 606 for displaying information to a computer user, an alpha-numeric input device 607 (e.g., a keyboard), and a cursor control device 608 (e.g., mouse, trackball, light pen, etc.) for inputting data, selections, updates, etc. Computer system 600 can also include a mechanism for emitting an audible signal (not shown).

Returning still to FIG. 6, optional display device 606 of FIG. 6 may be a liquid crystal device, cathode ray tube, or other display device suitable for creating graphic images and alpha-numeric characters recognizable to a user. Optional cursor control device 608 allows the computer user to dynamically signal the two dimensional movement of a visible symbol (cursor) on a display screen of display device 606. Many implementations of cursor control device 608 are known in the art including a trackball, mouse, touch pad, joystick, or special keys on alpha-numeric input 607 capable of signaling movement of a given direction or manner displacement. Alternatively, it will be appreciated that a cursor can be directed and/or activated via input from alpha-numeric input 607 using special keys and key sequence commands. Alternatively, the cursor may be directed and/or activated via input from a number of specially adapted cursor directing devices.

Furthermore, computer system 600 can include an input/output (I/O) signal unit (e.g., interface) 609 for interfacing with a peripheral device 610 (e.g., a computer network, modem, mass storage device, etc.). Accordingly, computer system 600 may be coupled in a network, such as a client/server environment, whereby a number of clients (e.g., personal computers, workstations, portable computers, minicomputers, terminals, etc.) are used to run processes for performing desired tasks. In particular, computer system 600 can be coupled in a system for providing cosmetics consulting .

The preferred embodiment of the present invention, a method and system for cosmetics consulting using a transmitted image, is thus described. While the present invention has been described in particular embodiments, it should be appreciated that the present invention should not be construed as limited by such embodiments, but rather construed according to the following claims.

1-39. (canceled)

40. A system for processing image data for product consultation, said system comprising:
an image capture system configured to capture an image of a user, and an image of a reference color set;
a categorizer configured to color analyze the captured image by a comparison of measured color signal values of the captured reference color set image with a known set of expected color signal values of the reference color set, and to determine an adjustment for color transformation of a color measurement of the user image based on the comparison;
a classifier configured to map the color measurement of the user image to a category, where each category is mapped to a result which identifies at least one personal appearance related product; and
a result generator configured to convey the personal appearance related product result to the user.

41. The system of claim 40, further comprising including an image display device configured to display a color corrected image of the user.

42. The system of claim 41, wherein the image display device is configured to display the color corrected image of the user as a composite image which includes the at least one personal appearance related product.

43. The system of claim 42, wherein the image display device is configured to display the composite image in real-time as a video.

44. The system of claim 40, comprising:
a product database; and
at least one of a product location database and a consumer relationship management database.

45. The system of claim 40, wherein said result is conveyed as a message selected from the group consisting of: an Internet message, a short message service (SMS) message, a multi-media message service (MMS) message, a voice message, a voice extensible mark-up language (voice XML) message, a printed message, an e-mail message, an electronic message, a delivery of a personal appearance related product, a message causing a product display to indicate said personal appearance related product, and a message causing said personal appearance related product to be dispensed.

46. The system of claim 40, wherein the captured user image includes skin color information of said user.

47. The system of claim 40, wherein the image capture system is one of a kiosk, a picture phone, a digital camera, a personal data assistant (PDA), a personal computer system and a digital video recorder.

48. The system of claim 40, wherein the reference color set is one of printed on a card, inserted into a magazine, or located on an in-house display for capture by the image capture system.

49. The system according to claim 40, wherein the classifier is configured to access a spectrum of complexion colors divided into a set of discrete bins.

50. The system according to claim 49, wherein sizes of the bins are not uniform.

51. The system of claim 40, comprising a categorizing system which includes:
a receiver;
the categorizer, communicatively coupled with the receiver;
the result generator; and
a result reporter configured to convey the personal appearance related product result using a message format.

52. A method for processing image data for associating personal appearance products with a user, said method comprising:
capturing an image including a user image and a color reference set image;
comparing measured color signal values of the captured color reference set image with a known set of expected color signal values;
determining an adjustment to color transform a color measurement of the user image in response to the comparing;
mapping the transformed user image to at least one data category of plural data categories;
generating a result based on the at least one category, the result identifying at least one personal appearance product; and
conveying the personal appearance product result to the user.

53. The method of claim 52, wherein the comparing includes:
determining a difference between the captured color reference set image and the known color reference set, the difference being indicative of color errors in the captured user image.

54. The method of claim 52, comprising:
identifying selected regions of the user image; and
determining a selected region which represents a skin coloration of the user.

55. The method of claim 52, wherein the determining includes:
applying the color transform to the color measurement of the captured user image.

56. The method of claim 52, wherein the mapping includes:
mapping the skin coloration of the user to subcutaneous pigmentation values.

57. The method of claim 52, comprising:
applying the adjustment to color measurements from selected portions of the captured user image.

58. The categorizing system of claim 52, wherein the plural data categories include skin complexion information.

59. The method of claim 58, wherein the mapping includes:
selecting a data category based on the skin complexion information.

60. The method of claim 58, wherein the plural data categories are based on plural regions of a face in the user image, the regions including two or more of the user's cheek, forehead and neck.

61. The method of claim 58, wherein the plural data categories are based on user demographic information.

62. The method of claim 52, wherein the personal appearance product result identifies a location of the at least one personal appearance product.

63. The method of claim 52, comprising:
displaying a composite image of the captured user image altered to represent the user wearing the at least one personal appearance product.

64. The method of claim 63, wherein displaying a composite image includes:
displaying a composite video image as a real-time video of the user image altered to include the at least one personal appearance product.
